(19) United States
(12) Patent Application Publication
(10) Pub. No.: US 2019/0086841 A1
(43) Pub. Date: Mar. 21, 2019

(54) INTERMEDIATE TRANSFER BODY, METHOD FOR MANUFACTURING INTERMEDIATE TRANSFER BODY, AND IMAGE FORMING DEVICE

(71) Applicant: Konica Minolta, Inc., Tokyo (JP)

(72) Inventors: Akihiro Honya, Tokyo (JP); Kazunori Kurimoto, Tokyo (JP); Teruo Sasaki, Tokyo (JP)

(21) Appl. No.: 16/116,410

(22) Filed: Aug. 29, 2018

(30) Foreign Application Priority Data
Sep. 21, 2017 (JP) 2017-180794

(51) Int. Cl. G03G 15/16; G03G 15/01; C08L 33/10; C08K 9/06; C08K 3/22

(52) U.S. Cl. CPC G03G 15/162; G03G 15/0157; C08L 33/10; C08K 2003/2227; C08K 3/22; C08K 2003/2231; C08K 9/06

(57) ABSTRACT

An intermediate transfer body used for an electrophotographic image forming device, includes: at least a base layer; and a surface layer, wherein the surface layer includes a polymer obtained by polymerizing a polyfunctional (meth)acrylic monomer and a monofunctional (meth)acrylic monomer, and metal oxide fine particles, the monofunctional (meth)acrylic monomer has an alkyl group having 6 or more carbon atoms, and the metal oxide fine particles are surface-modified with a reactive organic group having a structure represented by the following general formula (1). CH₂═C(R)COO(CH₂)ₙSi— General formula (1) [In the formula, R represents a hydrogen atom or a methyl group. n represents an integer of 3 to 6.]

The entire disclosure of Japanese patent Application No. 2017-180794, filed on Sep. 21, 2017, is incorporated herein by reference in its entirety.

### BACKGROUND

### Technological Field

The present invention relates to an intermediate transfer body, a method for manufacturing the intermediate transfer body, and an image forming device, particularly to an intermediate transfer body and the like suppressing chipping of a cleaning blade by improving dispersibility of a filler (metal oxide fine particles) and capable of preventing image failure derived from chipping.

### Description of the Related Art

In an electrophotographic image forming device, for example, a latent image formed on a photoreceptor is developed with toner, the obtained toner image is temporarily held on an endless belt-shaped intermediate transfer body, and the toner image on the intermediate transfer body is transferred onto a recording medium such as paper. As the shape of such an intermediate transfer body, an endless belt (intermediate transfer belt) is known.

The intermediate transfer belt includes a base layer made of a resin and a surface layer made of a curable resin disposed on the base layer. By forming the surface layer, it is expected to obtain both durability and high image quality. In particular, a technique for further improving durability by dispersing a filler in a surface layer to improve scratch resistance has been disclosed (for example, see JP 2013-024898 A).

However, in a case where compatibility between the filler and a monomer constituting the surface layer is not good, dispersibility of the filler in the surface layer is unstable to cause a problem such as aggregation.

In response to such a problem, there is a technique for suppressing aggregation of a filler by adding a dispersant (for example, see JP 2016-224445 A).

However, a surface layer made of a cured (meth)acrylic resin is a cured product of a monomer. Therefore, when a dispersant is added, incompatibility in the resin occurs, and a problem due to bleeding out occurs. In addition, the dispersant acts as a plasticizer, the hardness of the cured (meth)acrylic resin decreases, and therefore the durability cannot be improved as intended.

### SUMMARY

The present invention has been achieved in view of the above problems and circumstances. An object of the present invention is to provide an intermediate transfer body that improves dispersibility of a filler (metal oxide fine particles), hardly forms an aggregate of the filler in a surface layer after coating and drying, suppresses chipping of a cleaning blade due to the aggregate, and can prevent image failure derived from chipping throughout a service life of a belt, a method for manufacturing the intermediate transfer body, and an image forming device.

To achieve the abovementioned object, according to an aspect of the present invention, there is provided an intermediate transfer body used for an electrophotographic image forming device, and the intermediate transfer body reflecting one aspect of the present invention comprises:

at least a base layer; and a surface layer, wherein

the surface layer includes a polymer obtained by polymerizing a polyfunctional (meth)acrylic monomer and a monofunctional (meth)acrylic monomer, and metal oxide fine particles,

the monofunctional (meth)acrylic monomer has an alkyl group having 6 or more carbon atoms, and

the metal oxide fine particles are surface-modified with a reactive organic group having a structure represented by the following general formula (1).

CH₂═C(R)COO(CH₂)ₙSi— General formula (1)

[In the formula, R represents a hydrogen atom or a methyl group. n represents an integer of 3 to 6.]

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIGS. 1A to 1C are schematic diagrams of a monofunctional (meth)acrylic monomer and a metal oxide fine particle; and

FIG. 2 is a schematic diagram illustrating an example of an image forming device according to the present embodiment.

### DETAILED DESCRIPTION OF EMBODIMENTS

Hereinafter, one or more embodiments of the present invention will be described with reference to the drawings. However, the scope of the invention is not limited to the disclosed embodiments.

An intermediate transfer body according to an embodiment of the present invention is used for an electrophotographic image forming device, and includes at least a base layer and a surface layer, characterized in that the surface layer includes a polymer obtained by polymerizing a polyfunctional (meth)acrylic monomer and a monofunctional (meth)acrylic monomer, and metal oxide fine particles, the monofunctional (meth)acrylic monomer has an alkyl group having 6 or more carbon atoms, and the metal oxide fine particles are surface-modified with a reactive organic group having a structure represented by the above general formula (1). This characteristic is a technical characteristic common or corresponding to the invention according to the present embodiment.

In an embodiment of the present invention, the number of carbon atoms of an alkyl group of the monofunctional (meth)acrylic monomer is preferably 12 or more from a viewpoint of dispersibility of the metal oxide fine particles.

In addition, the (meth)acryloyl group of the monofunctional (meth)acrylic monomer is preferably an acryloyl group from a viewpoint of easily forming a micelle structure with the metal oxide fine particles.

In addition, in the above general formula (1), n is preferably 3 from a viewpoint of affinity with a hydrophilic group of the monofunctional (meth)acrylic monomer.

In addition, the content of a constituent derived from the monofunctional (meth)acrylic monomer is preferably within a range of 5 to 20 parts by volume with respect to the total volume (100 parts by volume) of the surface layer from a viewpoint of dispersibility of the metal oxide fine particles.

The number of functional groups of the polyfunctional (meth)acrylic monomer is preferably 5 or more from a viewpoint of excellent abrasion resistance.

In addition, in a method for manufacturing an intermediate transfer body according to an embodiment of the present invention, it is preferable to use a surface layer forming coating solution containing a monofunctional (meth)acrylic monomer within a range of 5 to 20 parts by volume with respect to the total volume (100 parts by volume) of solid components constituting the surface layer from a viewpoint of dispersibility of the metal oxide fine particles.

The intermediate transfer body according to an embodiment of the present invention is preferably used for an image forming device.

Hereinafter, the present invention, constituent elements thereof, and embodiments and modes for performing the present invention will be described in detail. Incidentally, in the present application, “to” means inclusion of numerical values described before and after “to” as a lower limit value and an upper limit value.

[Intermediate Transfer Body]

The intermediate transfer body primarily transfers a toner image carried on an electrostatic latent image carrier (photoreceptor), then secondarily transfers the primarily transferred toner image onto a recording medium, and is incorporated in the image forming device.

The intermediate transfer body includes a base layer and a surface layer. In addition, in the intermediate transfer body, the base layer is located inside, and the surface layer is located outside.

Note that an elastic layer constituted by an elastic body may be disposed between the base layer and the surface layer. An elastic layer having a known configuration can be used.

The intermediate transfer body has an endless belt shape. Here, the “endless belt shape” conceptually (geometrically) means, for example, a loop-like shape formed by joining both end portions of one elongated sheet-shaped material. The actual shape of the intermediate transfer body is preferably a seamless belt shape or a cylindrical shape.

<Base Layer>

The base layer is made of a resin and can be appropriately selected from resins not modified or deformed within a range of use temperature of the intermediate transfer body. Examples of resins used include polycarbonate, polyphenylene sulfide, polyvinylidene fluoride, polyimide, polyamide imide, polyalkylene terephthalate (polyethylene terephthalate, polybutylene terephthalate, or the like), polyether, polyether ketone, polyether ether ketone, an ethylene tetrafluoroethylene copolymer, and polyamide.

As the resin, it is preferable to contain polyimide, polycarbonate, polyphenylene sulfide, and polyalkylene terephthalate, and more preferable to contain polyphenylene sulfide or polyimide from a viewpoint of heat resistance and strength.

Polyimide can be obtained by heating polyamic acid that is a precursor of polyimide. In addition, polyamic acid can be obtained by dissolving a tetracarboxylic acid dianhydride or a substantially equimolar mixture of a derivative of a tetracarboxylic acid dianhydride and a diamine in an organic polar solvent, and allowing these compounds to react in a solution state. Incidentally, in a case where a polyimide-based resin is used as the base layer, the content of the polyimide-based resin in the base layer is preferably 51% or more.

In addition, the base layer preferably has an electric resistance value (volume resistivity) in a range of 10⁵ to 10¹¹ Ω·cm. In order to make the electric resistance value of the base layer within a predetermined range, the base layer only needs to contain, for example, a conductive material.

Examples of the conductive material include carbon black. As the carbon black, neutral or acidic carbon black can be used. Although varying depending on the type of conductive material, it is only required to add a conductive material such that the intermediate transfer body has a volume resistance value and a surface resistance value within a predetermined range. It is only required to add a conductive material usually within a range of 10 to 20 parts by mass, preferably within a range of 10 to 16 parts by mass with respect to 100 parts by mass of a resin.

In addition, the base layer preferably has a thickness within a range of 50 to 200 μm. Various known additives may be further added to the base layer. Examples of the additive include a dispersant such as a nylon compound.

The base layer can be manufactured by a conventionally known general method. For example, the base layer can be manufactured into an annular shape (endless belt shape) by melting a heat resistant resin as a material by an extruder, shaping the melted product into a tubular shape by an inflation method using an annular die, and then cutting the shaped product into round slices.

<Surface Layer>

The surface layer contains a polymer obtained by polymerizing a polyfunctional (meth)acrylic monomer and a monofunctional (meth)acrylic monomer, and metal oxide fine particles. Here, the “(meth)acrylic monomer” means an acrylic monomer or a methacrylic monomer.

The monofunctional (meth)acrylic monomer has an alkyl group having 6 or more carbon atoms.

In addition, the (meth)acryloyl group of the monofunctional (meth)acrylic monomer is preferably an acryloyl group.

(Monofunctional (Meth)Acrylic Monomer)

The monofunctional (meth)acrylic monomer (also referred to as a “long-chain alkyl monofunctional monomer”) has a hydrophobic long-chain alkyl group and a functional group (reactive group) that is a (meth)acryloyl group.

The monofunctional (meth)acrylic monomer is more preferably an alkyl monofunctional monomer in which 12 or more carbon atoms are continuously connected from a viewpoint of dispersibility of metal oxide fine particles. An upper limit value of the number of carbon atoms is preferably 25 or less from a viewpoint of easy availability and excellent solubility.

The monofunctional (meth)acrylic monomer may have a branched structure, but the number of connected carbon atoms is calculated as the number of continuously connected carbon atoms in a carbon chain having the largest length in a molecule. For example, in a case where a long-chain alkyl moiety is ethylhexyl, the carbon number of the long-chain alkyl moiety is eight, but the number of continuous carbon atoms is calculated as an alkyl monofunctional monomer in which six carbon atoms are connected continuously.

Note that “connected continuously” means a series of bonds between carbon atoms, and no other element is allowed to be interposed therebetween.

The content of a constituent (component) derived from the monofunctional (meth)acrylic monomer is preferably within a range of 1 to 30 parts by volume, particularly preferably within a range of 5 to 20 parts by volume with respect to the total volume (100 parts by volume) of the surface layer. Within the above range, the metal oxide fine particles are dispersed favorably, and an intermediate transfer body having a smooth surface can be obtained.

In the present invention, as a method for analyzing components constituting the surface layer, a generally used method can be used. As a method for analyzing a composition ratio of a monomer, it is possible to use solid NMR or a method for identifying a structure after hydrolyzing a shaped product using NMR, GC-MS, LC-MS, or the like to determine a molar fraction.

In addition, as a method for calculating a volume ratio of each component, the volume ratio can be calculated by multiplying the molar fraction determined as described above by a specific gravity. As the specific value, a general value such as a maker value may be used.

In the present invention, calculation can be performed by assuming that the specific gravities of components constituting the surface layer are 0.9 for a monofunctional (meth)acrylic monomer, 1.1 for a polyfunctional (meth)acrylic monomer, 3.5 for alumina as the metal oxide fine particles, 6.3 for tin oxide, 3.7 for titania, and 2.2 for silica.

Examples of the long-chain alkyl group include n-butyl, n-pentyl, n-hexyl, n-octyl, n-nonyl, n-decanyl, lauryl, myristyl, palmityl, cetyl, stearyl, behenyl, 2-ethylhexyl, isooctyl, isononyl, isodecanyl, isolauryl, isomyristyl, isopalmityl, isocetyl, isostearyl, and 2-decyltetradecanyl.

(Metal Oxide Fine Particles)

The metal oxide fine particles are characterized by being surface-modified with a reactive organic group having a structure represented by the following general formula (1).

CH₂═C(R)COO(CH₂)ₙSi— General formula (1)

[In the formula, R represents a hydrogen atom or a methyl group. n represents an integer of 3 to 6.]

In general formula (1), n is preferably 3.

The surface-modified metal oxide fine particles can be obtained by surface-modifying metal oxide fine particles that have not been treated (hereinafter also referred to as “untreated metal oxide fine particles”) with a specific surface modifier.

The untreated metal oxide fine particles only need to be formed of an oxide of a metal including a transition metal, and examples thereof include silica (silicon oxide), magnesium oxide, zinc oxide, lead oxide, aluminum oxide (alumina), tantalum oxide, indium oxide, bismuth oxide, yttrium oxide, cobalt oxide, copper oxide, manganese oxide, selenium oxide, iron oxide, zirconium oxide, germanium oxide, tin oxide, titanium oxide, niobium oxide, molybdenum oxide, and vanadium oxide.

The untreated metal oxide fine particles are preferably formed of titanium oxide, aluminum oxide (alumina), zinc oxide, or tin oxide, and more preferably formed of aluminum oxide (alumina) or tin oxide from a viewpoint of imparting toughness and durability.

As the untreated metal oxide fine particles, those manufactured by a general manufacturing method such as a vapor phase method, a chlorine method, a sulfuric acid method, a plasma method, or an electrolysis method can be used.

The untreated metal oxide fine particles have a number average primary particle diameter preferably within a range of 1 to 300 nm, more preferably within a range of 3 to 100 nm. In a case where the number average primary particle diameter is 1 nm or more, abrasion resistance is sufficient. In a case where the number average primary particle diameter is 300 nm or less, dispersibility is favorable, and the particles are hardly precipitated in a coating solution. In addition, the particles do not inhibit photocuring of the surface layer, and favorable abrasion resistance is obtained.

The number average primary particle diameter of the untreated metal oxide fine particles is determined by photographing an enlarged photograph at a magnification of 10000 times with a scanning electron microscope (manufactured by JEOL Ltd.), capturing randomly selected 300 particles by a scanner to obtain a photographic image (except for aggregated particles), and calculating a number average primary particle diameter of the particles using an automatic image processing analyzer “(trade name: LUZEX AP” manufactured by Nireco Corporation) Software Version Ver. 1.32.

A surface modifier used for manufacturing the metal oxide fine particles surface-modified with a reactive organic group having the structure represented by the above general formula (1) according to an embodiment of the present invention is a compound represented by the above general formula (1). Examples of the compound having a (meth)acryloyl group include the compounds represented by S-1 to S-30 in Table I.

TABLE 1
Table I

| No. | Structural formula |
|---|---|
| S-1 | CH₂═CHSi(CH₃)(OCH₃)₂ |
| S-2 | CH₂═CHSi(OCH₃)₃ |
| S-3 | CH₂═CHSiCl₃ |
| S-4 | CH₂═CHCOO(CH₂)₂Si(CH₃)(OCH₃)₂ |
| S-5 | CH₂═CHCOO(CH₂)₂Si(OCH₃)₃ |
| S-6 | CH₂═CHCOO(CH₂)₂Si(OC₂H₅)(OCH₃)₂ |
| S-7 | CH₂═CHCOO(CH₂)₃Si(OCH₃)₃ |
| S-8 | CH₂═CHCOO(CH₂)₂Si(CH₃)Cl₂ |
| S-9 | CH₂═CHCOO(CH₂)₂SiCl₃ |
| S-10 | CH₂═CHCOO(CH₂)₃Si(CH₃)Cl₂ |
| S-11 | CH₂═CHCOO(CH₂)₃SiCl₃ |
| S-12 | CH₂═C(CH₃)COO(CH₂)₂Si(CH₃)(OCH₃)₂ |
| S-13 | CH₂═C(CH₃)COO(CH₂)₂Si(OCH₃)₃ |
| S-14 | CH₂═C(CH₃)COO(CH₂)₃Si(CH₃)(OCH₃)₂ |
| S-15 | CH₂═C(CH₃)COO(CH₂)₃Si(OCH₃)₃ |
| S-16 | CH₂═C(CH₃)COO(CH₂)₂Si(CH₃)Cl₂ |
| S-17 | CH₂═C(CH₃)COO(CH₂)₂SiCl₃ |
| S-18 | CH₂═C(CH₃)COO(CH₂)₃Si(CH₃)Cl₂ |
| S-19 | CH₂═C(CH₃)COO(CH₂)₃SiCl₃ |
| S-20 | CH₂═CHSi(C₂H₅)(OCH₃)₂ |
| S-21 | CH₂═C(CH₃)Si(OCH₃)₃ |
| S-22 | CH₂═C(CH₃)Si(OC₂H₅)₃ |
| S-23 | CH₂═CHSi(OCH₃)₃ |
| S-24 | CH₂═C(CH₃)Si(CH₃)(OCH₃)₂ |
| S-25 | CH₂═CHSi(CH₃)Cl₂ |
| S-26 | CH₂═CHCOOSi(OCH₃)₃ |
| S-27 | CH₂═CHCOOSi(OC₂H₅)₃ |
| S-28 | CH₂═C(CH₃)COOSi(OCH₃)₃ |
| S-29 | CH₂═C(CH₃)COOSi(OC₂H₅)₃ |
| S-30 | CH₂═C(CH₃)COO(CH₂)₃Si(OC₂H₅)₃ |

Examples of a surface modifying method include a method using a wet media dispersion type device using 0.1 to 200 parts by volume of a surface modifier and 50 to 5000 parts by volume of a solvent with respect to 100 parts by volume of untreated metal oxide fine particles.

In addition, by dispersing a slurry (suspension of solid particles) containing the untreated metal oxide fine particles and a surface modifier in a wet manner, an aggregate of the untreated metal oxide fine particles is disintegrated, and surface modification of the untreated metal oxide fine particles proceeds at the same time. Thereafter, a solvent is removed, and powderization is performed. Therefore, uniform and finer metal oxide fine particles surface-modified with the surface modifier can be obtained.

The amount of surface modification with the surface modifier (the amount of coating with the surface modifier) is preferably within a range of 0.1 to 60% by mass with respect to the metal oxide fine particles. The amount is particularly preferably within a range of 5 to 40% by mass.

Since this surface modifier contains Si, the amount of surface modification is determined by thermally treating surface-modified metal oxide fine particles at 550° C. for three hours, quantitatively analyzing the strong heat residue with fluorescent X-rays, and converting the Si amount into a molecular weight.

The above wet media dispersion type device can execute a step of pulverizing and dispersing aggregated particles of the metal oxide fine particles by filling beads as media in a container and rotating a stirring disk attached perpendicularly to a rotating shaft at a high speed. As a configuration of the device, it is possible to adopt a device capable of dispersing the untreated metal oxide fine particles sufficiently when the untreated metal oxide fine particles are surface-modified and performing surface modification without any particular problem. For example, various types such as a vertical type, a horizontal type, a continuous type, and a batch type can be adopted. Specific examples thereof include a sand mill, an ultra visco mill, a pearl mill, a glen mill, a dyno mill, an agitator mill, and a dynamic mill. These dispersion type devices perform fine pulverization and dispersion by impact crushing, friction, shearing, shear stress, and the like using a pulverizing medium such as balls or beads. As the beads used in the dispersion type device, balls made of glass, alumina, zircon, zirconia, steel, flintstone, or the like can be used, and beads made of zirconia or zircon are particularly preferable. In addition, as the sizes of the beads, beads each having a diameter of about 1 to 2 mm are usually used. However, in the present embodiment, beads each having a diameter of about 0.3 to 1.0 mm are preferably used.

Various materials such as stainless steel, nylon, and ceramic can be used for a disk and an inner wall of a container used for the wet media dispersion type device. However, in the present embodiment, a ceramic material such as zirconia or silicon carbide is particularly preferably adopted.

By the wet treatment as described above, the metal oxide fine particles surface-modified with a reactive organic group having the structure represented by the above general formula (1) (that is, surface-modified metal oxide fine particles) can be obtained.

The surface-modified metal oxide fine particles as described above are included preferably in an amount of 5 to 40 parts by volume, more preferably in an amount of 10 to 30 parts by volume with respect to 100 parts by volume of a polymer obtained by polymerizing a monofunctional (meth)acrylic monomer and a polyfunctional (meth)acrylic monomer. If the content of the metal oxide fine particles is within a range of 5 to 40 parts by volume, the hardness of the intermediate transfer body is lowered, and there is no possibility that transferability and durability are lowered. In addition, there is no possibility that a surface layer is brittle and easily broken or coating unevenness occurs during manufacturing.

(Polyfunctional (Meth)Acrylic Monomer)

The polyfunctional (meth)acrylic monomer is a monomer having a bifunctional or higher functional reactive group, and is preferably pentafunctional or higher from a viewpoint of favorable abrasion resistance.

The polyfunctional (meth)acrylic monomer needs to be a main component of monomers. The main component is present in an amount of 50% or more by volume in monomers.

The polyfunctional (meth)acrylic monomers may be mixed to be used.

Specific examples of the polyfunctional (meth)acrylic monomers include compounds of the following formulas (1) to (19).

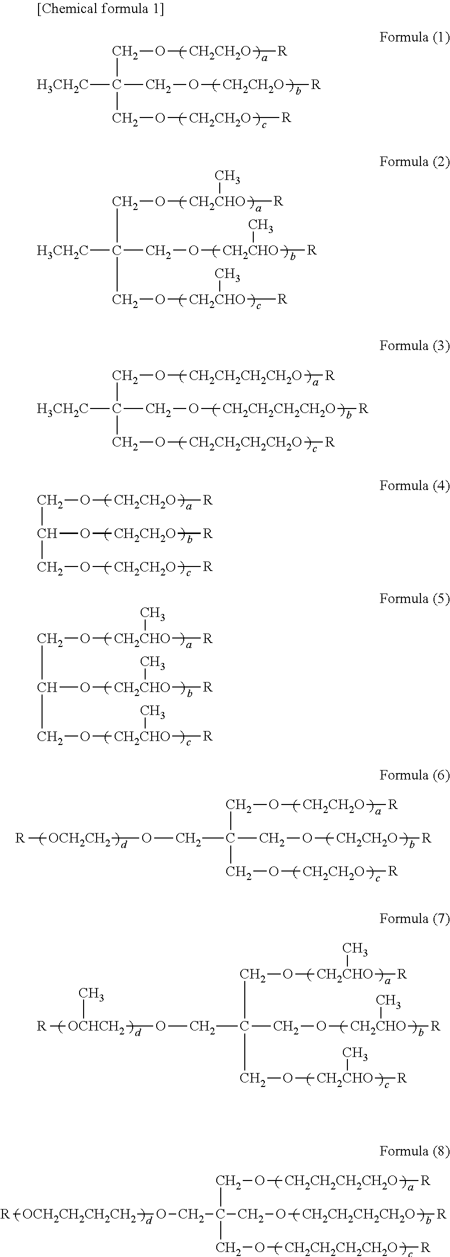

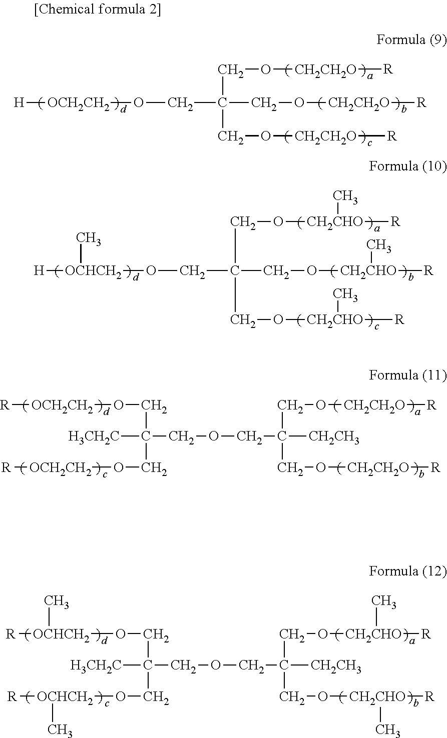

In the compounds of the above formulas (1) to (5), R represents an acryloyl group or a methacryloyl group, a, b, and c each represent 0 or a positive integer, and a+b+c≤15 is satisfied. However, Rs in the same molecule all represent the same group. Note that the sum of a, b, and c is the number of alkylene structures, and the number of Rs (that is, three) is the number of (meth)acryloyl groups.

In the compounds of the formulas (6) to (12), R represents an acryloyl group or a methacryloyl group, a, b, c, and d each represent 0 or a positive integer, and a+b+c+d≤20 is satisfied. However, Rs in the same molecule all represent the same group. Note that the sum of a, b, c, and d is the number of alkylene structures, and the number of Rs is the number of (meth)acryloyl groups.

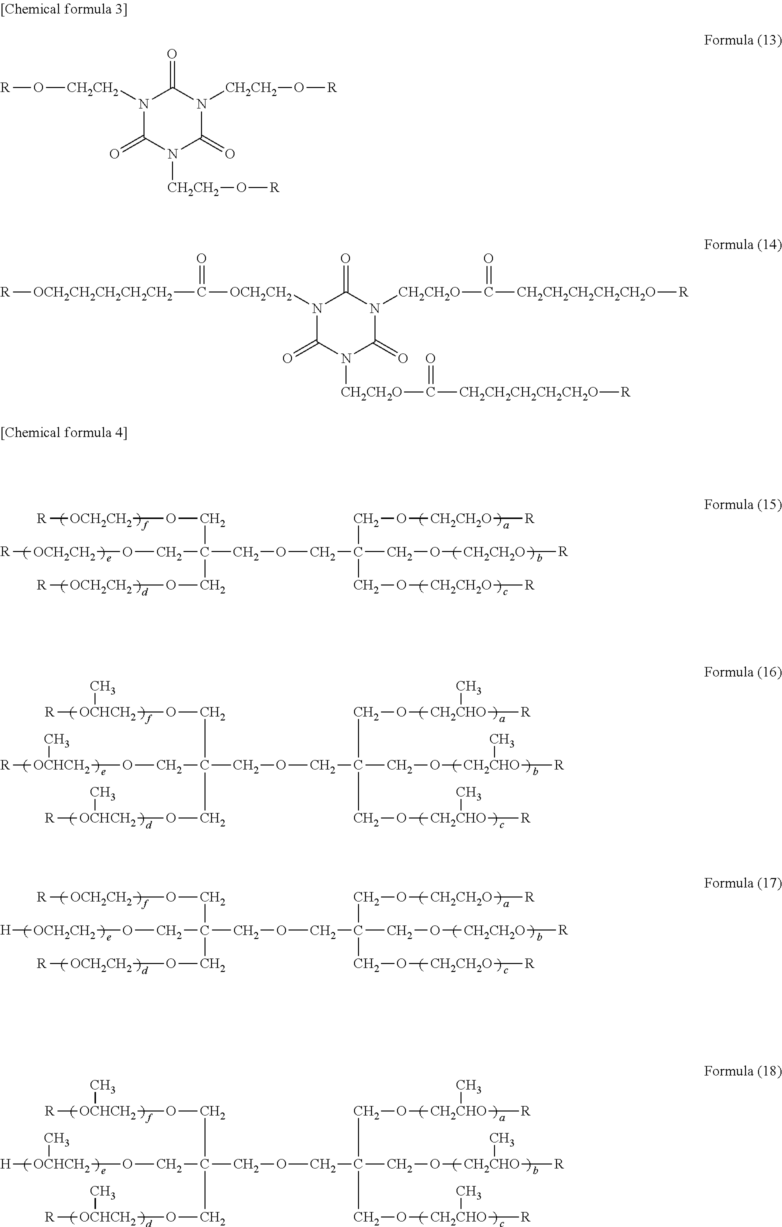

In the compounds of the above formulas (13) and (14), R represents an acryloyl group or a methacryloyl group. However, Rs in the same molecule all represent the same group.

In the compounds of the formulas (15) to (18), R represents an acryloyl group or a methacryloyl group, a, b, c, d, e, and f each represent 0 or a positive integer, and a+b+c+d+e+f≤30 is satisfied. However, Rs in the same molecule all represent the same group. Note that the sum of a, b, c, d, e, and f is the number of alkylene structures, and the number of Rs is the number of (meth)acryloyl groups.

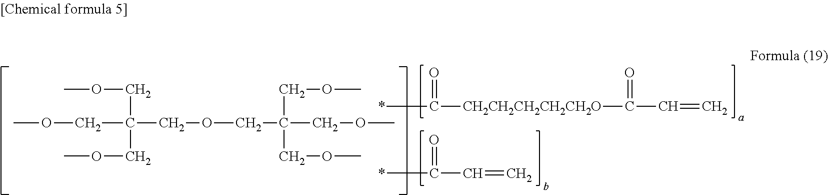

In the compound of the above formula (19), R represents an acryloyl group or a methacryloyl group, a and b each represent an integer of 1 or more, and a+b=6 is satisfied. However, Rs in the same molecule all represent the same group. Note that formula (19) indicates that substitution is randomly performed with two types of groups represented by the right formulas at six substitution positions in the left formula.

In addition, the surface layer according to an embodiment of the present invention may contain a polyfunctional (meth)acrylic monomer other than the polyfunctional (meth)acrylic monomer.

More specifically, the “polyfunctional (meth)acrylic monomer other than the polyfunctional (meth)acrylic monomer” has two or more (meth)acryloyl groups in one molecule. Examples thereof include a bifunctional monomer such as bis(2-acryloxyethyl)-hydroxyethyl-isocyanurate, 1,6-hexanediol diacrylate, 1,3-butylene glycol diacrylate, 1,4-butanediol diacrylate, 1,9-nonanediol diacrylate, 1,10-decanediol diacrylate, neopentyl glycol diacrylate, polyethylene glycol diacrylate, polypropylene glycol diacrylate, polytetramethylene glycol diacrylate, dioxane glycol diacrylate, ethoxylated bisphenol A diacrylate, propoxylated bisphenol A diacrylate, alkoxylated bisphenol A diacrylate, tricyclodecane dimethanol diacrylate, propoxylated neopentyl glycol diacrylate, alkoxylated neopentyl glycol diacrylate, hydroxypivalic acid neopentyl glycol diacrylate, or urethane acrylate; and a trifunctional or higher polyfunctional monomer such as trimethylolpropane triacrylate (TMPTA), pentaerythritol triacrylate, tris(acryloxyethyl) isocyanurate, ditrimethylolpropane tetraacrylate, pentaerythritol tetraacrylate (PETTA), dipentaerythritol hexaacrylate (DPHA), urethane acrylate, or an ester synthesized from a polyhydric alcohol, a polybasic acid, and (meth)acrylic acid (for example, an ester synthesized from trimethylol ethane/succinic acid/acryl acid=2/1/4 mol), but are not limited thereto.

The surface layer according to an embodiment of the present invention may further contain another additive. The additive is appropriately added to the surface layer, for example, by adding the additive to a curable composition. The other additive may be added to the curable composition in order to impart appropriate physical properties for manufacturing the surface layer.

Examples of the other additive include a polymerization initiator, an organic solvent, a light stabilizer, an ultraviolet absorber, a catalyst, a colorant, an antistatic agent, a lubricant, a leveling agent, a defoaming agent, a polymerization accelerator, an antioxidant, a flame retardant, an infrared absorber, a surfactant, and a surface modifier.

The intermediate transfer body according to an embodiment of the present invention can be manufactured by, for example, applying a surface layer forming coating solution containing the above-described polymer obtained by polymerizing a monofunctional (meth)acrylic monomer and a polyfunctional (meth)acrylic monomer, the surface-modified metal oxide fine particles, and as necessary, the above additive onto the base layer and irradiating the coating solution with active energy rays so as to obtain a predetermined light amount.

The surface layer forming coating solution preferably contains a monofunctional (meth)acrylic monomer within a range of 5 to 20 parts by volume with respect to the total volume (100 parts by volume) of solid components constituting the surface layer.

[Image Forming Device]

As long as including the above-described intermediate transfer body according to an embodiment of the present invention, the image forming device according to an embodiment of the present invention can adopt a known configuration as a configuration other than the intermediate transfer body without any particular limitation.

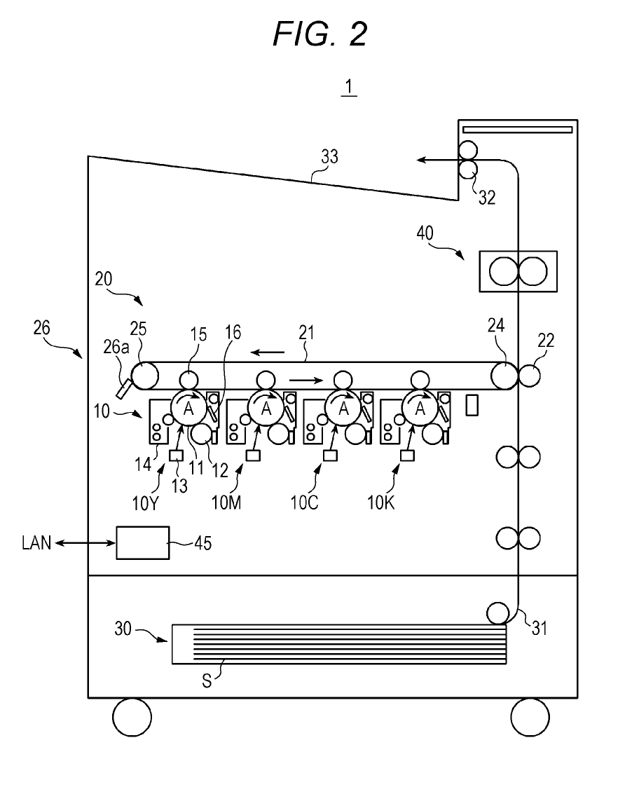

FIG. 2 is a schematic diagram illustrating an example of the image forming device according to an embodiment of the present invention.

As illustrated in FIG. 2, an image forming device 1 forms an image on a recording medium by a known electrophotographic method, includes an image forming section 10, an intermediate transfer unit 20, a sheet conveyer 30, a fixer 40, and a controller 45, and selectively executes color and monochrome printing based on a print job accepted from an external terminal device (not illustrated) via a network (for example, LAN).

The image forming section 10 includes image forming units 10Y to 10K corresponding to developing colors of yellow (Y), magenta (M), cyan (C), and black (K), respectively. The image forming unit 10Y includes a photosensitive drum 11 as an electrostatic latent image carrier, a charging device 12 disposed around the photosensitive drum 11, an exposing device 13, a developing device 14, a primary transfer roller 15, a photosensitive cleaning device 16, a belt cleaning device 26, and a secondary transfer roller 22.

The photosensitive drum 11 is, for example, a negatively charged organic photoreceptor and rotates in a direction indicated by the arrow A. The charging device 12 charges a peripheral surface of the photosensitive drum 11. The charging device 12 is, for example, a corona charger. The charging device 12 may be a contact charging device that charges a contact charging member such as a charging roller, a charging brush, or a charging blade in contact with the photosensitive drum 11. The exposing device 13 includes, for example, a semiconductor laser as a light source and a light deflecting device (polygon motor) that emits laser light according to an image to be formed toward the photosensitive drum 11.

The developing device 14 houses a developer containing toner therein and develops an electrostatic latent image on the photosensitive drum 11 with the toner to form a toner image on the photosensitive drum 11. That is, the toner image is thereby carried on the electrostatic latent image carrier. Here, the “toner image” refers to a state in which toner is aggregated in an image shape.

As the toner, known toner can be used. The toner may be a one-component developer or a two-component developer. The one-component developer is formed of toner particles. In addition, the two-component developer is formed of toner particles and carrier particles. Each of the toner particles is formed of a toner base particle and an external additive attached to a surface of the toner base particle, such as silica or a lubricant. Each of the toner base particles is formed of, for example, a binder resin, a colorant, and a wax.

The type of the lubricant is not particularly limited. Examples of the type of the lubricant include a metal soap such as zinc stearate, zinc palmitate, zinc myristate, zinc laurate, zinc behenate, magnesium stearate, calcium stearate, or aluminum stearate, various fatty acids, a fatty acid amide, a fatty acid ester, an aliphatic alcohol having 18 to 70 carbon atoms, a polyethylene, various waxes, polytetrafluoroethylene (PTFE), and various inorganic materials each having a layered crystal structure (boron nitride, melamine cyanurate, molybdenum disulfide, graphite fluoride, mica, or the like). Known types of lubricants can be used.

The lubricant is preferably a metal soap of a stearate or a zinc salt of a fatty acid, and particularly preferably zinc stearate from a viewpoint of easiness of spreading. In addition, the particle diameter of the lubricant is not particularly limited. However, the lubricant preferably has an average particle diameter of 10 μm or less from viewpoints of being able to increase the number of particles supplied per unit area, increasing spreading efficiency, and more easily exerting an effect of decreasing a dynamic frictional force as the diameter is smaller.

The intermediate transfer unit 20 includes an intermediate transfer body 21 stretched by a driving roller 24 and a driven roller 25 and circulating and traveling in a direction indicated by the arrow. The intermediate transfer body 21 has a seamless belt shape (that is, an endless belt shape), and has a cylindrical shape obtained by injection molding or centrifugal molding of a resin material so as to have a desired peripheral length determined by a design.

The belt cleaning device 26 includes a cleaning member (cleaning blade) 26a. The secondary transfer roller 22 is driven together with the driven roller 25 to secondarily transfer a toner image primarily transferred onto the intermediate transfer body 21 onto a recording medium.

Incidentally, in a case where color printing (color mode) is executed, each of the image forming units 10M to 10K forms a toner image of a color corresponding thereto on the photosensitive drum 11, and the formed toner image is transferred onto the intermediate transfer body 21. This image forming operation of each color of Y to K is executed in such a manner that the timing is shifted from an upstream side toward a downstream side such that the toner images of the respective colors overlap with one another to be transferred onto the same position of the traveling intermediate transfer body 21.

The sheet conveyer 30 sends out a sheet S as a recording medium one by one from a sheet feeding cassette in accordance with the above image forming timing and conveys the sheet S thus sent out on a conveyance path 31 toward the secondary transfer roller 22. The sheet S is heated and pressurized by the fixer 40. Toner on a surface of the sheet S is thereby fused and fixed to the surface of the sheet S. Thereafter, the sheet S is discharged onto a paper ejection tray 33 by a paper ejection roller 32. In this way, an image corresponding to a toner image is formed on a recording medium.

The sheet S onto which each color toner image has been secondarily transferred is conveyed to the fixer 40, and is heated and pressurized by the fixer 40. Toner on a surface of the sheet S is thereby fused and fixed to the surface of the sheet S. Thereafter, the sheet S is discharged onto the paper ejection tray 33 by the paper ejection roller 32. In this way, an image corresponding to a toner image is formed on a recording medium.

Incidentally, in the above, the operation in the case of executing a color mode has been described. However, in a case of executing printing in monochrome, for example, printing in black (monochrome mode), only the image forming unit 10K for black is driven, and black image formation (printing) is executed on the recording sheet S through charging, exposure, development, transfer, and fixing for black by a similar operation to the above.

The controller 45 controls each unit based on data of a print job accepted from an external terminal device via a network, and causes each unit to execute a smooth printing operation.

[Image Forming Method]

An image forming method according to an embodiment of the present invention includes: a primary transfer step of transferring a toner image carried on the photosensitive drum 11 onto the intermediate transfer body 21; a secondary transfer step of transferring the toner image carried on the intermediate transfer body 21 onto a recording medium; and a cleaning step of bringing the cleaning member 26a into contact with a surface of the intermediate transfer body 21 after the secondary transfer step to remove a residual toner remaining on the surface, and includes, for example, a charging step, an exposure step, a developing step, a transfer step, and a fixing step. In addition, the image forming method may further include a step of applying a lubricant having an average particle diameter of 10 μm or less to the intermediate transfer body 21.

In order to perform the image forming method according to the present embodiment, a device configured similarly to the image forming device 1 described above can be used.

In the charging step, a photosensitive drum is charged by a charging device or the like. The photosensitive drum is, for example, a negatively charged organic photoreceptor having photoconductivity. The organic photoreceptor includes, for example, a conductive support, a charge generation layer, a charge transport layer, and a surface layer.

In the exposure step, a charged photosensitive drum is irradiated with light by an exposure device or the like to form an electrostatic latent image.

In the developing step, toner is supplied to the photosensitive drum on which the electrostatic latent image is formed to form a toner image corresponding to the electrostatic latent image. The developing step can be performed using a known developing device in an electrophotographic image forming device, for example.

In the transfer step, the toner image on the photosensitive drum 11 is transferred onto the recording medium using a transfer unit. In the present embodiment, the transfer step includes a primary transfer step and a secondary transfer step. In the primary transfer step, the toner image on the photosensitive drum 11 is transferred onto the intermediate transfer body 21 by an electrostatic action using the primary transfer roller 15. In the secondary transfer step, the toner image on the intermediate transfer body 21 is transferred onto the recording medium using the secondary transfer roller 22. As described above, the image forming method according to the present embodiment is substantially an intermediate transfer method.

In the fixing step, the toner image transferred onto the recording medium is fixed to the recording medium by a known fixing device or the like.

Note that a drum cleaning step of removing toner remaining on the photosensitive drum 11 may be performed on the photosensitive drum 11 after the primary transfer. In addition, a belt cleaning step of removing toner remaining on the intermediate transfer body 21 may be performed on the intermediate transfer body 21 after the secondary transfer. The belt cleaning step is performed using the belt cleaning device 26 including the belt cleaning member (cleaning member) 26a. The belt cleaning device 26 cleans toner particles remaining on a surface of the intermediate transfer body 21 after transferring the toner image onto the recording medium by bringing the cleaning member 26a into contact with the surface. Examples of a method for cleaning residual toner particles include a method using a pressed cleaning blade, a method using a dedicated pressed blade for applying a lubricant, a method using a pressed brush, a method using a pressed rubber roller, a method using a pressed sponge roller, and a method using a pressed ultrathin (thickness: 0.3 mm or less) metal plate. The method for cleaning the residual toner particles is preferably a method using a cleaning blade from a viewpoint of reducing the number of required parts.

In addition, the method may further include a step of applying a lubricant to the intermediate transfer body 21. The step of applying a lubricant to the intermediate transfer body 21 is not particularly limited as long as being able to apply a lubricant to the intermediate transfer body 21. A lubricant may be directly applied to the intermediate transfer body 21 while the lubricant is scraped off from a solid lubricant with a brush or the like. Alternatively, using toner particles containing a lubricant therein, the lubricant may be supplied to the intermediate transfer body 21 by the toner. In the present embodiment, the step of applying a lubricant to the intermediate transfer body is a step of supplying the lubricant to the intermediate transfer body by toner using toner particles containing the lubricant therein. Note that the average particle diameter of the lubricant is 10 μm or less in any applying step.

As described above, in the present embodiment, since the intermediate transfer body 21 according to an embodiment of the present invention described above is used, adhesion to a cleaning blade is improved, and image failure derived from chipping of the blade hardly occurs. In addition, the intermediate transfer body 21 according to an embodiment of the present invention includes a base layer and a surface layer having hardness and flexibility, and in particular, contains no plasticizer component such as a dispersant. Therefore, the intermediate transfer body 21 also has excellent abrasion resistance.

### Examples

Hereinafter, the present invention will be specifically described with reference to Examples, but the present invention is not limited thereto.

### [Manufacture of Intermediate Transfer Body 1]

### (1) Manufacture of Base Layer 1

A base layer for an intermediate transfer body was manufacture according to the following method.

Into a single screw extruder, 100 parts by mass of polyphenylene sulfide (PPS) (E2180, manufactured by Toray Industries, Inc.), 16 parts by mass of carbon black (Furnace #3030B, manufactured by Mitsubishi Chemical Corporation), 1 part by mass of an ethylene glycidyl methacrylate-acrylonitrile styrene copolymer (Modiper A4400, manufactured by NOF CORPORATION), and 0.2 parts by mass of calcium montanate were put and melt-kneaded to obtain a resin mixture.

Subsequently, an annular die having a slit-shaped and seamless belt-shaped discharge port was attached to a tip of the single screw extruder, and the kneaded resin mixture was extruded into a seamless belt shape. The extruded seamless belt-shaped resin mixture was extrapolated to a cylindrical cooling cylinder disposed at a discharge destination and cooled to be solidified, and a seamless cylindrical resin base layer 1 having a thickness of 120 μm was thereby manufactured.

### (2) Manufacture of Metal Oxide Fine Particles 1

With respect to 100 parts by volume of tin oxide fine particles having a number average primary particle diameter of 34 nm (Nanotek SnO₂: manufactured by CIK Nanotech), 1 part by volume of 3-methacryloxypropyl trimethoxysilane [surface modifier of n=3, KBM-503, manufactured by Shin-Etsu Chemical Co., Ltd.) and 2000 parts by volume of a solvent (mixed solvent of toluene:isopropyl alcohol=1:1 (volume ratio)) were mixed, and dispersed using a wet media dispersion type device. The solvent was removed, and the resulting product was dried at 150° C. for 30 minutes to obtain surface-modified metal oxide fine particles 1.

### (3) Preparation of Surface Layer Forming Coating Solution 1

In methyl isobutyl ketone (MIBK), 50 parts by volume of ethoxylated (12) dipentaerythritol hexaacrylate (ethoxylated (12) DPHA) (KAYARAD DPEA-12: manufactured by Nippon Kayaku Co., Ltd.), 15 parts by volume of acetyl acrylate (NOF CORPORATION), and 35 parts by volume of the metal oxide fine particles 1 were dissolved and dispersed so as to obtain a solid concentration of 20% by volume to prepare a diluted solution. With respect to 100 parts by mass of the diluted solution, 1 part by mass of a photopolymerization initiator (Irgacure OXE02; manufactured by BASF) and 0.3 parts by mass of a tertiary amine (KAYACURE EPA, manufactured by Nippon Kayaku Co., Ltd.) were mixed to prepare a surface layer forming coating solution 1 as a composition containing a polyfunctional (meth)acrylic monomer, a monofunctional (meth)acrylic monomer, and metal oxide fine particles.

### (4) Manufacture of Intermediate Transfer Body 1

Using a coating device (refer to JP 2012-145677 A for a manufacturing device), the surface layer forming coating solution 1 was applied onto an outer peripheral surface of the resin base layer 1 manufactured in the above by an immersion coating method under the following coating conditions so as to have a dry layer thickness of 4 μm to form a coated film. By irradiating the coated film with ultraviolet rays as active energy rays under the following irradiation conditions, the coated film was cured to form a surface layer, and the intermediate transfer body 1 was manufactured.

Note that the coated film was irradiated with ultraviolet rays while a light source was fixed and the resin base layer 1 having the coated film formed on an outer peripheral surface thereof was rotated at a peripheral rate of 60 mm/s.

<<Coating Conditions>>

Coating solution supply amount: 1 L/min

Pulling rate: 10 mm/s

<<Ultraviolet Ray Irradiation Conditions>>

Type of light source: 365 nm LED light source (SPX-TA, manufactured by Revox Inc.)

Distance from irradiation port to surface of coated film: 100 mm

Atmosphere: nitrogen

Irradiation light amount: 1 J/cm²

Irradiation time (time of rotating resin base layer): 240 seconds

[Manufacture of Intermediate Transfer Bodies 2 to 19]

Intermediate transfer bodies 2 to 19 were manufactured in a similar manner to the manufacture of the intermediate transfer body 1 except that the materials were changed as illustrated in Table II in preparation of the surface layer forming coating solution 1 of the intermediate transfer body 1.

Note that the materials described in Table are as follows.

Polyfunctional (meth)acrylic monomer

DPCA-60 (caprolactone-modified dipentaerythritol hexaacrylate, manufactured by Nippon Kayaku Co., Ltd.)

A-DPH-6PA (PO-modified dipentaerythritol hexaacrylate, manufactured by Shin-Nakamura Chemical Co., Ltd.)

SR9003 (SR9003 (PO-modified neopentyl alcohol diacrylate, manufactured by Sartomer)

AD-TMP (ditrimethylolpropane tetraacrylate, manufactured by Shin-Nakamura Chemical Co., Ltd.)

DPHA (dipentaerythritol hexaacrylate, manufactured by Nippon Kayaku Co., Ltd.)

PETTA (pentaerythritol hexaacrylate, manufactured by Shin-Nakamura Chemical Co., Ltd.)

Monofunctional (Meth)Acrylic Monomer

LMA (lauryl methacrylate, manufactured by Kyoeisha Chemical Co., Ltd.)

ID (isodecyl methacrylate, manufactured by Kyoeisha Chemical Co., Ltd.)

BMA (behenyl methacrylate, manufactured by NOF CORPORATION)

BA (behenyl am/late, manufactured by NOF CORPORATION)

S-A (stem/lam/late, manufactured by NOF CORPORATION)

EH (ethylhexyl methacrylate, manufactured by Kyoeisha Chemical Co., Ltd.)

DTD-MA (2-decyltetradecanyl methacrylate, manufactured by Kyoeisha Chemical Co., Ltd.)

LA (lauryl acrylate)

NB (normal butyl methacrylate; manufactured by Kyoeisha Chemical Co., Ltd.)

6-HHA (6-hydroxyhexyl acrylate; manufactured by BOC Science)

Metal Oxide Fine Particles

Silica (Nanotek SiO₂, 25 nm silica fine particles, manufactured by CIK Nanotech)

Titania (MT-500B, 35 nm titania fine particles, manufactured by Tayca Corporation)

Alumina (Nanotek Al₂O₃, 30 nm alumina fine particles, manufactured by CIK Nanotech)

Surface Modifier

KBM-5103 (3-acryloxypropyltrimethoxysilane, surface modifier of n=3, manufactured by Shin-Etsu Chemical Co., Ltd.)

KBM-5803 (8-methacryloxyoctyltrimethoxysilane, surface modifier of n=8, manufactured by Shin-Etsu Chemical Co., Ltd.)

KF-9901 (methyl hydrogen polysiloxane, manufactured by Shin-Etsu Chemical Co., Ltd.)

SZ-31 (hexamethyldisilazane, manufactured by Shin-Etsu Chemical Co., Ltd.)

Dispersant

Dispersant A (polymeric dispersant, DISPERBYK-168, manufactured by BYK-Chemie)

[Evaluation]

(1) Evaluation of Blade Chipping

As an evaluation machine for evaluating blade chipping, as illustrated in FIG. 2, a full-color image forming device (bizhub C554 manufactured by Konica Minolta, Inc. (intermediate transfer body tandem color multifunction machine that performs laser exposure and reversal development)) on which the intermediate transfer bodies 1 to 19 can be mounted was prepared. Each of the intermediate transfer bodies was mounted on the evaluation machine, and a blade state and slip of toner were evaluated in an initial stage and after a durability test.

For the durability test, an image having a printing ratio of 2.5% for each of yellow (Y), magenta (M), cyan (C), and black (Bk) at 20° C. and 50% RH was printed on five hundred thousand sheets.

The evaluation criteria are as illustrated below. A case where an evaluation result was “⊚”, “◯” or “Δ” was judged to be usable.

(Evaluation Criteria)

⊚: There was no chip on a blade, and streaky stains due to slip did not occur at all.

◯: One or two chips were observed on a blade, but streaky stains due to slip did not occur.

Δ: Three to five chips were observed on a blade, and streaky stains due to slip occurred slightly.

x: A large number of chips were observed on a blade, and streaky stains due to slip occurred obviously.

(2) Evaluation of Dispersion Stability of Coating Solution

A surface layer forming coating solution was allowed to stand at 30° C. for 14 days. Thereafter, a surface layer was formed, and defects on a surface of a belt were evaluated.

(Evaluation Criteria)

◯: No particular problem occurred, and a coated film was equivalent to that before being allowed to stand.

Δ: 1 to 3 protruding defects due to aggregation were observed.

x: A large number of foreign matters due to aggregation were observed.

TABLE II

| | Polyfunctional (meth)acrylic monomer | | | | Monofunctional (meth)acrylic monomer | | | |
|---|---|---|---|---|---|---|---|---|
| Intermediate | | | Number of | | | Number of | | |
| transfer | | Functional | functional | Part by | | carbon atoms | Functional | Part by |
| body | Constituent | group | groups | volume | Constituent | in alkyl group | group | volume |
| 1 | DPEA-12 | Acryloyl | 6 | 50 | CA | 16 | Acrylic | 15 |
| 2 | DPCA-60 | Acryloyl | 6 | 50 | LMA | 12 | Methacryloyl | 15 |
| 3 | A-DPH-6PA | Acryloyl | 6 | 50 | ID | 7 | Methacryloyl | 15 |
| 4 | SR9003 | Acryloyl | 2 | 50 | BMA | 22 | Methacryloyl | 15 |
| 5 | A-DPH-6PA | Acryloyl | 6 | 50 | BA | 22 | Acryloyl | 15 |
| 6 | SR9003 | Acryloyl | 2 | 60 | DTD-MA | 14 | Methacryloyl | 5 |
| 7 | A-DPH-6PA | Acryloyl | 6 | 45 | S-A | 18 | Acryloyl | 20 |
| 8 | DPEA-12 | Acryloyl | 6 | 50 | EH | 6 | Methacryloyl | 15 |
| 9 | AD-TMP | Methacryloyl | 4 | 50 | LA | 12 | Acryloyl | 15 |
| 10 | DPEA-12 | Acryloyl | 6 | 35 | EH | 6 | Methacryloyl | 30 |
| 11 | A-DPH-6PA | Acryloyl | 6 | 64 | BA | 22 | Acryloyl | 1 |
| 12 | DPHA | Acryloyl | 6 | 50 | S-A | 18 | Acryloyl | 15 |
| 13 | PETTA | Acryloyl | 4 | 50 | ID | 7 | Methacryloyl | 15 |
| 14 | DPEA-12 | Acryloyl | 6 | 50 | S-A | 18 | Acryloyl | 15 |
| 15 | DPHA | Acryloyl | 6 | 50 | LA | 12 | Acryloyl | 15 |
| 16 | DPEA-12 | Acryloyl | 6 | 50 | NB | 4 | Acryloyl | 15 |
| 17 | DPEA-12 | Acryloyl | 6 | 50 | 6-HHA | — | Acryloyl | 15 |
| 18 | DPEA-12 | Acryloyl | 6 | 50 | S-A | 18 | Acryloyl | 15 |
| 19 | DPEA-12 | Acryloyl | 6 | 75 | — | — | — | — |

| Intermediate | Metal oxide fine particles | | | | Evaluation | | |
|---|---|---|---|---|---|---|---|
| transfer | | Surface | Part by | | Blade | Dispersion | |
| body | Type | modifier | volume | Additive | chipping | stability | Note |
| 1 | Tinoxide | KBM-503 | 35 | — | ◯ | ◯ | Present invention |
| 2 | Silica | KBM-503 | 35 | — | ◯ | ◯ | Present invention |
| 3 | Titania | KBM-5103 | 35 | — | ◯ | Δ | Present invention |
| 4 | Titania | KBM-503 | 35 | — | ◯ | Δ | Present invention |
| 5 | Alumina | KBM-5103 | 35 | — | ⊙ | ◯ | Present invention |
| 6 | Silica | KBM-503 | 35 | — | ◯ | ◯ | Present invention |
| 7 | Titania | KBM-503 | 35 | — | ⊙ | ◯ | Present invention |
| 8 | Tinoxide | KBM-503 | 35 | — | ◯ | ◯ | Present invention |
| 9 | Tinoxide | KBM-503 | 35 | — | ◯ | Δ | Present invention |
| 10 | Silica | KBM-5103 | 35 | — | ◯ | Δ | Present invention |
| 11 | Silica | KBM-503 | 35 | — | ◯ | ◯ | Present invention |
| 12 | Silica | KBM-503 | 35 | — | ◯ | ◯ | Present invention |
| 13 | Tinoxide | KBM-503 | 35 | — | ◯ | Δ | Present invention |
| 14 | Silica | KF-9901 | 35 | — | X | Δ | Comparative Example |
| 15 | Tinoxide | SZ-31 | 35 | — | X | X | Comparative Example |
| 16 | Silica | KBM-503 | 35 | — | X | Δ | Comparative Example |
| 17 | Silica | KBM-503 | 35 | — | X | X | Comparative Example |
| 18 | Silica | KBM-5803 | 35 | — | X | Δ | Comparative Example |
| 19 | Silica | KBM-503 | 26 | Dispersant A | — | ◯ | Comparative Example |

The results illustrated in Table II indicate that the intermediate transfer bodies 1 to 13 did not generate an aggregate because metal oxide fine particles were dispersed favorably, and that no image failure due to blade chipping occurred.

Each of the intermediate transfer bodies 14 and 15 does not have a structure represented by general formula (1) on surfaces of metal oxide fine particles, and therefore did not obtain a dispersion effect due to a long-chain alkyl group included in a monofunctional (meth)acrylic monomer. As a result, blade chipping occurred to cause image failure.

In the intermediate transfer body 16, the number of carbon atoms of an alkyl group in a monofunctional (meth)acrylic monomer is small, and a dispersion effect due to metal oxide fine particles was small. As a result, blade chipping occurred to cause image failure.

In the intermediate transfer body 17, a monofunctional (meth)acrylic monomer has 6 or more carbon atoms, but a terminal is a hydroxy group. Therefore, metal oxide fine particles were aggregated, and blade chipping occurred to cause image failure.

The intermediate transfer body 18 has a structure represented by general formula (1) on surfaces of metal oxide fine particles, but could not form a favorable micelle structure due to n=8 to increase surface roughness. As a result, blade chipping occurred to cause image failure.

In the intermediate transfer body 19, dispersibility of a filler was favorable due to a dispersant, but bleeding occurred on a surface of a belt, and image failure due to bleeding was observed.

According to an embodiment of the present invention, it is possible to provide an intermediate transfer body that improves dispersibility of metal oxide fine particles, hardly forms an aggregate of the metal oxide fine particles in a surface layer after coating and drying, suppresses chipping of a cleaning blade due to the aggregate, and can prevent image failure derived from chipping throughout a service life of a belt, a method for manufacturing the intermediate transfer body, and an image forming device.

An exhibition mechanism or an action mechanism of an effect of an embodiment of the present invention has not been clarified but is estimated as follows.

According to an embodiment of the present invention, by using a monofunctional monomer having a long-chain alkyl group and metal oxide fine particles surface-modified with a reactive organic group having a structure represented by the above general formula (1) in combination for a surface layer, the metal oxide fine particles are dispersed favorably, precipitation of the metal oxide fine particles in a coating solution hardly occurs, and aggregation can be prevented.

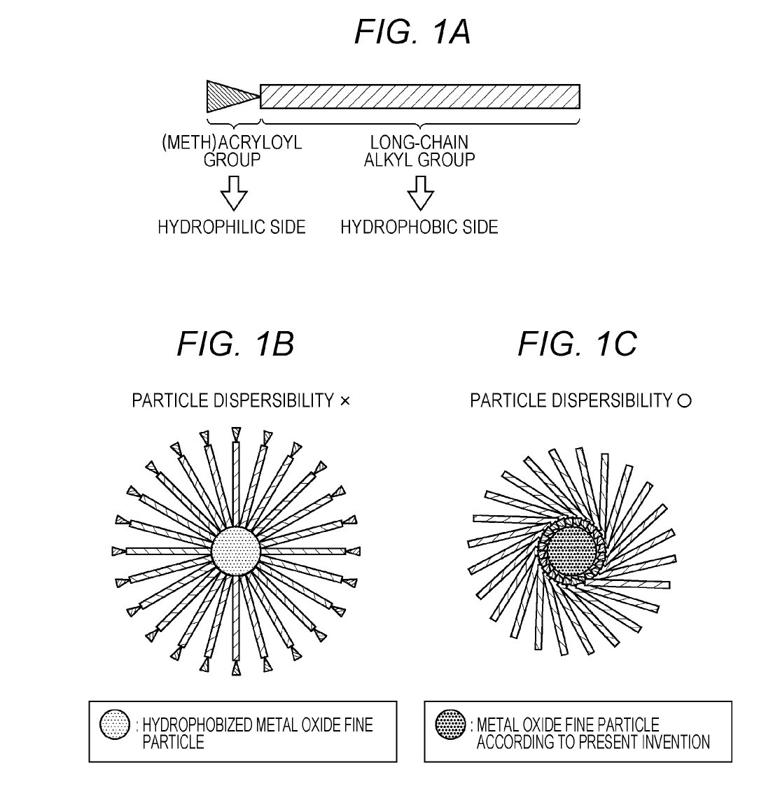

Generally, in a long-chain alkyl monofunctional monomer, as illustrated in FIG. 1A, a long-chain alkyl group has a hydrophobic property, and a (meth)acryloyl group has a hydrophilic property. Therefore, in a case where a metal oxide fine particle having a hydrophobic group on a surface thereof is used, as illustrated in FIG. 1B, a monofunctional monomer having a (meth)acryloyl group is orientated to the outside, and a long-chain alkyl group is orientated to a side of the metal oxide fine particle having a hydrophobic group. Meanwhile, in the present invention, by using a metal oxide fine particle surface-modified with a reactive organic group having a structure represented by the above general formula (1), as illustrated in FIG. 1C, a monofunctional monomer covers the metal oxide fine particle with a long-chain alkyl group oriented to the outside. As a result, a micelle structure hardly causing aggregation is formed, and dispersibility of the metal oxide fine particles is favorable.

As a result, a surface of a coated film is smooth, adhesion to a cleaning blade is improved, and image failure derived from chipping of the blade hardly occurs. In addition, because of including a base layer and a surface layer having hardness and flexibility, and in particular, containing no plasticizer component such as a dispersant, excellent abrasion resistance is also obtained.

Although embodiments of the present invention have been described and illustrated in detail, the disclosed embodiments are made for purposes of illustration and example only and not limitation. The scope of the present invention should be interpreted by terms of the appended claims.

What is claimed is:

1. An intermediate transfer body used for an electrophotographic image forming device, comprising:
at least a base layer; and a surface layer, wherein
the surface layer includes a polymer obtained by polymerizing a polyfunctional (meth)acrylic monomer and a monofunctional (meth)acrylic monomer, and metal oxide fine particles,
the monofunctional (meth)acrylic monomer has an alkyl group having 6 or more carbon atoms, and
the metal oxide fine particles are surface-modified with a reactive organic group having a structure represented by the following general formula (1).
CH₂═C(R)COO(CH₂)ₙSi— General formula (1)
[In the formula, R represents a hydrogen atom or a methyl group. n represents an integer of 3 to 6.]

2. The intermediate transfer body according to claim 1, wherein the alkyl group of the monofunctional (meth)acrylic monomer has 12 or more carbon atoms.

3. The intermediate transfer body according to claim 1, wherein a (meth)acryloyl group of the monofunctional (meth)acrylic monomer is an acryloyl group.

4. The intermediate transfer body according to claim 1, wherein n is 3 in the general formula (1).

5. The intermediate transfer body according to claim 1, wherein the content of a constituent derived from the monofunctional (meth)acrylic monomer is within a range of 5 to 20 parts by volume with respect to the total volume (100 parts by volume) of the surface layer.

6. The intermediate transfer body according to claim 1, wherein the number of functional groups of the polyfunctional (meth)acrylic monomer is 5 or more.

7. A method for manufacturing the intermediate transfer body according to claim 1, wherein
a surface layer forming coating solution containing a monofunctional (meth)acrylic monomer within a range of 5 to 20 parts by volume with respect to the total volume (100 parts by volume) of solid components constituting the surface layer is used.

8. An image forming device comprising the intermediate transfer body according to claim 1.
